(19) United States
(12) Patent Application Publication
(10) Pub. No.: US 2011/0205750 A1
(43) Pub. Date: Aug. 25, 2011

(54) LIGHTING ASSEMBLY

(75) Inventors: Marcellinus Petrus Carolus Michael Krijn, Eindhoven (NL); Hugo Johan Cornelissen, Eindhoven (NL); Hendrik Adrianus Van Sprang, Eindhoven (NL)

(73) Assignee: KONINKLIJKE PHILIPS ELECTRONICS N.V., Eindhoven (NL)

(21) Appl. No.: 12/672,555

(22) PCT Filed: Aug. 11, 2008
(86) PCT No.: PCT/IB2008/053210

§ 371 Date: Feb. 8, 2010

(30) Foreign Application Priority Data
Aug. 16, 2007 (EP) 07114403.4

(51) Int. Cl. F21V 8/00

(52) U.S. Cl. 362/551

(57) ABSTRACT

A lighting assembly has a light source emitting light, an angular filter having a main surface, and a light guide having a main surface. The main surface of the filter is parallel to the main surface of the light guide. The filter may be configured to reflect light rays originating from the light source that are incident at small angles with respect to a direction normal to the main surface of the filter, and to transmit light rays originating from the light source that are incident at larger angles with respect to the direction normal to the main surface of the filter.

### FIELD OF THE INVENTION

The present invention relates to coupling light into a light guide. The present invention further relates to a backlight structure for an LCD (Liquid Crystal Display).

### BACKGROUND OF THE INVENTION

When light from a light source is incident on a flat unstructured light guide, no light will be coupled into the light guide. Some light will be reflected (indicated as so-called Fresnel reflection), and the remainder of the light will be transmitted through the light guide. Accordingly, in the prior art, when light is to be coupled into a light guide having a generally plate-shaped structure, special provisions are made at the light guide to allow a light source to couple the light into the light guide.

For example, if a side-emitting LED (Light Emitting Diode) is used as a light source, a hole or recession must be made in a main surface of the light guide to allow the light source to be accommodated at a location inside the light guide. To provide such a hole or recession, the light guide must be relatively thick, resulting in a relatively high mass and volume of the light guide. Further, optimum operation of the light source in the hole or recession requires a good registration of the light source and the hole or recession, which is complicated.

In another known structure, an LED is arranged at an edge of a light guide to allow light emitted by the LED to enter a surface of the light guide at right angles to a main surface of the light guide. Again, in such an arrangement, the light guide must be relatively thick.

A planar or plate-shaped light guide may be used as a luminaire for LCD (Liquid Crystal Display) backlighting as well as for general lighting. Light is transported inside the light guide by means of TIR (Total Internal Reflection), and light is coupled out of the light guide by outcoupling means known per se, such as a diffuser.

### OBJECT OF THE INVENTION

It is desirable to provide a lighting assembly comprising a light source and a light guide, in which assembly the light guide may be planar or plate-shaped (flat, with opposing main surfaces of the plate-shaped light guide being essentially parallel, or wedge-shaped, with opposing main surfaces of the plate-shaped light guide including a small angle) and very thin.

### SUMMARY OF THE INVENTION

In an embodiment of the present invention, a lighting structure is provided, the lighting structure comprising: a light source emitting light; an angular filter having a main surface; and a light guide having a main surface. The main surface of the filter is parallel to the main surface of the light guide. In such a lighting assembly, the light guide may be made very thin, thus reducing its mass and volume. The light source is a light source emitting light in a relatively narrow wavelength range. An example of such a light source is an LED.

In this specification, the term angular filter may refer to a filter structure that reflects light rays incident at small angles with respect to a direction normal to a main surface of the filter, and transmits light rays incident at larger angles with respect to the direction normal to the main surface of the filter, or it may refer to a filter structure that transmits light rays incident at small angles with respect to a direction normal to a main surface of the filter, and reflects light rays incident at larger angles with respect to the direction normal to the main surface of the filter. An angular filter may be embodied as a dichroic filter, which may also be referred to as a dichroic mirror, or as a photonic crystal, or as any array of diffractive elements, or as a combination thereof.

The claims and advantages will be more readily appreciated as the same becomes better understood by reference to the following detailed description and the accompanying drawings showing exemplary embodiments, in which like reference symbols designate like parts. For clarity, various parts of the embodiments in the drawings are not drawn to scale.

### BRIEF DESCRIPTION OF THE DRAWINGS

FIG. 1 schematically depicts a cross-section of a first embodiment of a lighting assembly according to the present invention.

FIG. 2 shows an emission and a transmission curve, as a function of wavelength.

FIG. 3 shows a transmission versus angle of incidence curve for a dichroic filter.

FIG. 4 shows an emission and several transmission curves for different angles of incidence, as a function of wavelength.

FIG. 5 schematically depicts a cross-section of a second embodiment of a lighting assembly according to the present invention.

FIG. 6 schematically depicts a cross-section of a third embodiment of a lighting assembly according to the present invention.

FIG. 7 schematically depicts a cross-section of a fourth embodiment of a lighting assembly according to the present invention.

FIG. 8a schematically depicts a cross-section of a fifth embodiment of a lighting assembly according to the present invention.

FIG. 8b schematically depicts a cross-section of a sixth embodiment of a lighting assembly according to the present invention.

### DETAILED DESCRIPTION OF EXAMPLES

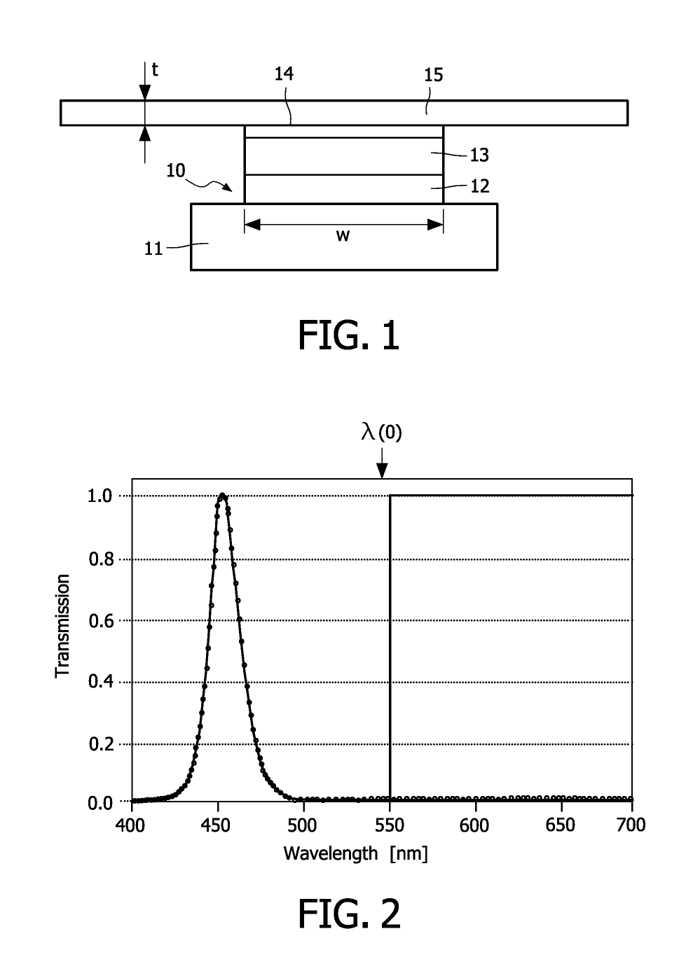

FIG. 1 schematically shows a light source embodied as an LED 10 comprising a heat conductor 11, a light-producing structure 12, and a sapphire structure 13. Typically, the LED 10 is manufactured by depositing a layered structure of group III-V semiconductors, such as InGaN (light-producing structure 12), on a sapphire substrate (sapphire structure 13) by means of MOCVD (Organo Metallic Chemical Vapour Deposition). The combination of the light-producing structure 12 and the sapphire structure 13 is provided with electrical contacts and in a flip-chip geometry bonded to the heat conductor 11.

The sapphire structure 13 is covered with a dichroic filter 14, i.e. a multi-layer filter structure that reflects light rays (generated in the light producing structure 12 and transmitted in the sapphire structure 13) travelling at small angles with respect to a direction normal to a main surface of the filter 14, and transmits light rays travelling at larger angles with respect to said normal direction. Thus, a main surface of the LED 10 is in mechanical and optical contact with a first main surface of the filter 14.

A second main surface of the filter 14 lying opposite to the first main surface is in mechanical and optical contact with a main surface of a light guide 15.

It is to be noted that mechanical contact between parts may be direct or indirect, such as by an intermediate layer of material, such as a layer of glue.

It is to be noted further that a ‘main surface’ of a part of a lighting assembly implies that said part has at least one dimension along the main surface being greater than a dimension normal to the main surface.

It is to be noted further that the sapphire structure 13 is optional, and need not be present in the lighting assembly. In a process of manufacture of the lighting assembly, it may e.g. be removed from the light-producing structure 12 before the dichroic filter 14 is applied. In that case, the dichroic filter 14 may have its first main surface in mechanical and optical contact with the light-producing structure 12.

The lighting assembly of FIG. 1 comprising the LED 10, the dichroic filter 14 and the light guide 15 functions as described in the following.

The dichroic filter 14 is configured such that it reflects light emitted by the light-producing structure 12 at small angles θ_{guide} inside the light guide to the direction normal to the main surface of the filter 14 and transmits light that is emitted at angles θ_{guide} larger than a critical angle θ_{guide,critical} into the light guide 15. The critical angle θ_{guide,critical} is the smallest possible angle that fulfils TIR (Total Internal Reflection) in the light guide 15. For a light guide 15 surrounded by air, TIR implies:

θ_{guide}≧θ_{guide,critical}=a sin(1/n_{guide}) (1)

where n_{guide} is the index of refraction of the light guide 15.

From Snell's law and formula (1), it follows that the dichroic filter 14 transmits light inside the LED 10 for angles θ_{LED} with respect to a direction normal to a main surface of the LED 10 that obey relation (2):

$$sin ( {θ}_{LED} ) \geq \frac{{n}_{guide}}{{n}_{LED}} sin ( {θ}_{guide , critical} ) \qquad ( 2 )$$

where n_{LED} is the (effective) index of refraction in the LED 10.

Light emitted by the LED 10 that is reflected back to the LED 10 has a chance of being absorbed again, which has to be avoided as much as possible. The minimum thickness tₘᵢₙ of the light guide 15 that is needed to ensure that a light ray injected into the light guide 15 will not be able to reach the LED 10 again is given by formula (3):

$${t}_{min} = \frac{w}{2 tan ( {θ}_{guide , critical} )} \qquad ( 3 )$$

where w is the effective width of the LED 10.

As an example, the width w of an LED typically is 1 mm, and n_{guide} typically is 1.5, implying that the thickness of the light guide 15 may be as small as tₘᵢₙ=0.6 mm.

In the foregoing, the dichroic filter 14 has been presented as reflecting light for angles less than a critical angle θ_{guide,critical} with respect to a direction normal to a main surface of the filter, and transmitting light for angles larger than the critical angle θ_{guide, critical}. In the following, it will be explained that the critical angle may be chosen at will.

Reference is made to FIG. 2, showing on the left-hand side a typical spectrum (light intensity versus light wavelength) of a blue LED as measured, as an example. Also shown in FIG. 2 on the right-hand side is a transmission characteristic of a hypothetical low-pass filter (i.e. a filter passing frequencies lower than a cut-off frequency, or equivalently, a filter passing wavelengths larger than a cut-off wavelength) for normal incidence of light. It is assumed that the cut-off wavelength is λ(0), as indicated in FIG. 2. This cut-off wavelength λ(0) will shift to smaller values when an angle of incidence of light with respect to the normal direction of the filter is increased. This shift follows approximately relation (4):

$$λ ( θ ) = λ ( 0 ) \sqrt{1 - {( \frac{{n}_{LED}}{{n}_{filter}} )}^{2} {sin}^{2} ( θ )} \qquad ( 4 )$$

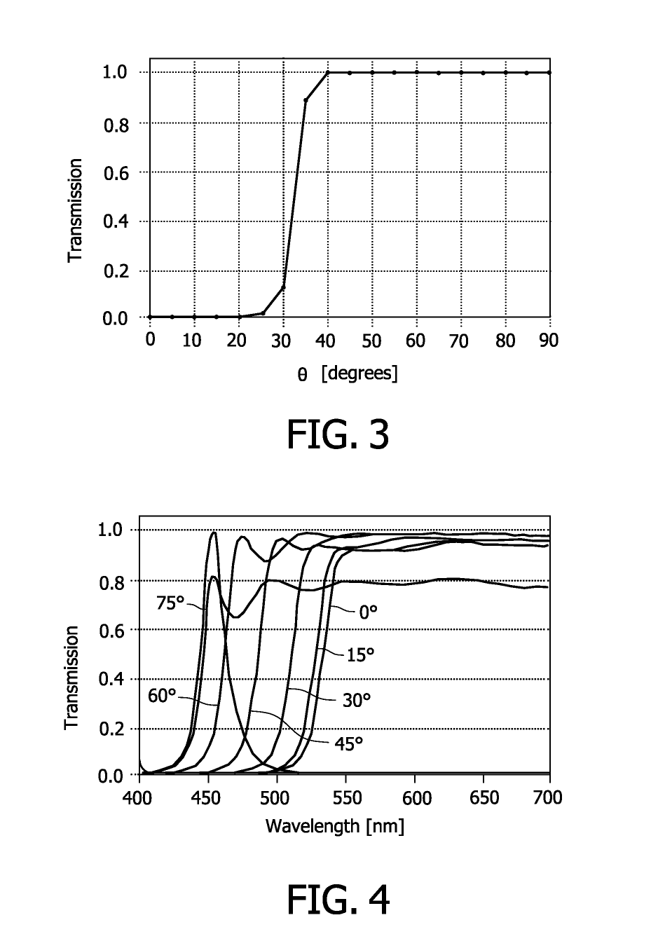

In relation (4), n_{LED} and n_{filter} are the indices of refraction of the LED material in contact with the filter, and an average index of refraction of the filter, respectively, and θ is an angle of light incidence relative to the normal direction. Relation (4) in combination with the measured LED spectrum as shown in FIG. 2, results in a relation between transmission and angle of incidence θ of light onto the filter as shown in FIG. 3.

As an example, λ(0)=550 nm, n_{LED}=1.8 and n_{filter}=1.75 were taken. In FIG. 4, the emission spectrum of the blue LED as depicted in FIG. 2 is shown again, as well as various transmission curves for different angles (0°, 15°, 30°, 45°, 60° and 75°) of incidence θ. From the overlap of the emission curve and the transmission curves, it can be seen that the light of the particular LED will be blocked for angles of incidence between 0° and 30°, and will be transmitted for angles of incidence greater than 30°, in particular from 45° to 75°. Indeed, as FIG. 4 shows, at small angles, the filter reflects light, whereas at larger angles, the light is transmitted. It is noted that the presented data apply for one specific polarization state of the light.

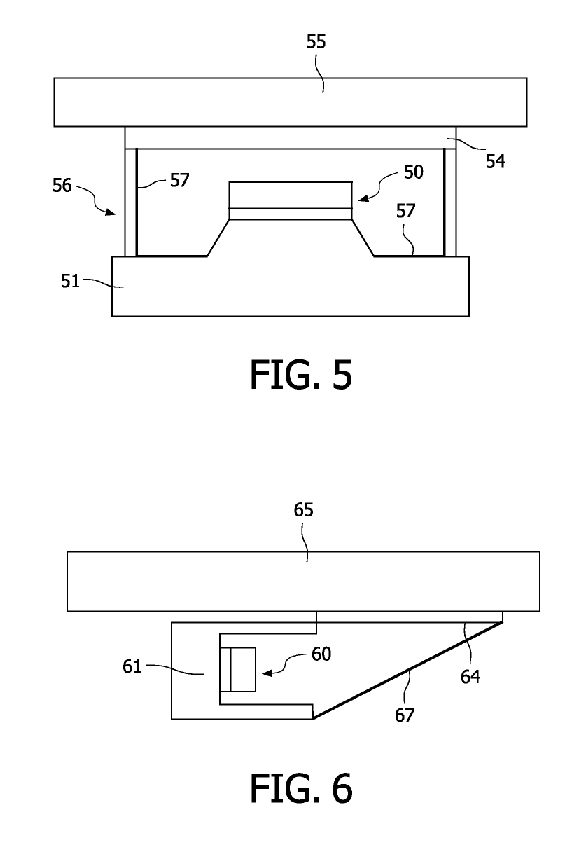

In an embodiment of a lighting assembly illustrated in FIG. 5, a dichroic filter 54 is coupled optically to a light guide 55, whereas an LED 50 mounted on a heat conductor 51 is decoupled (spaced) from the dichroic filter 54. Here, the dichroic filter 54 is designed such that it reflects light rays travelling at small angles with respect to a direction normal to a main surface of the filter, whereas light rays travelling at larger angles with respect to the normal direction are transmitted. The LED 50 is surrounded by a structure 56 having a shape which is optimized to minimize the chance that light emitted by the LED 50 is able to reach the LED 50 again. The structure 56 is provided with an inner lining 57 having a high (diffuse) reflectance, such that light rays from the light source and reflected by the lining 57 of the structure 56 enter the filter 54. These measures serve to reduce the chance that a light ray that is reflected by the dichroic filter 54 reaches the LED 50 again and is absorbed by the LED 50.

In an embodiment of a lighting assembly illustrated in FIG. 6, an LED 60 mounted on a heat conductor 61 is used in a side-emitting geometry, where light rays emitted by the LED 60 are reflected by a mirror 67 to redirect the light rays such that most of these rays are transmitted by a dichroic filter 64 coupled to a light guide 65, and are captured inside the light guide 65 by TIR. Here, the dichroic filter 64 is designed such that it reflects light rays travelling at small angles with respect to a direction normal to a main surface of the filter, whereas light rays travelling at larger angles with respect to the normal direction are transmitted.

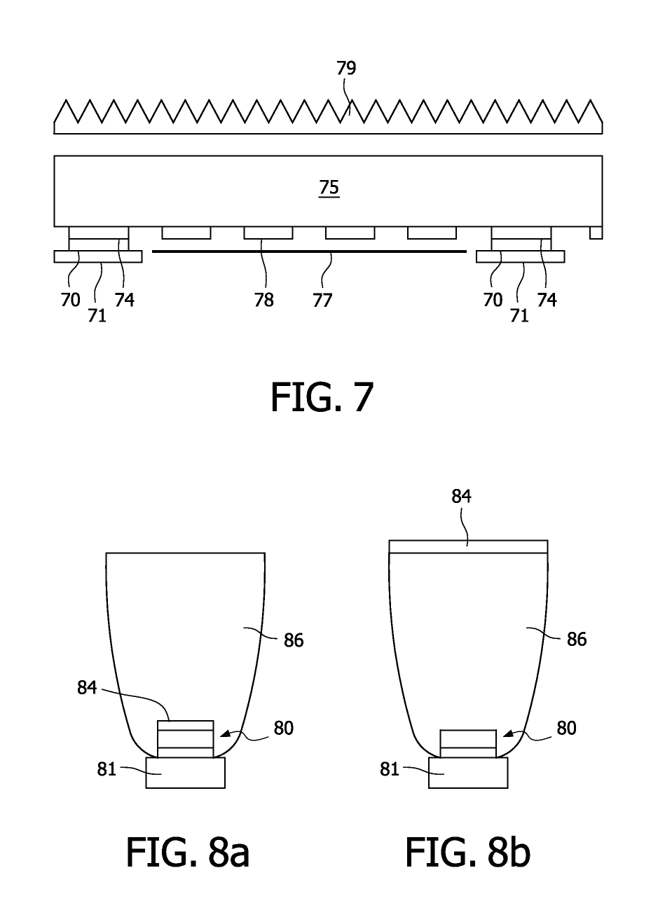

In an embodiment of a lighting assembly illustrated in FIG. 7, light from LEDs 70 mounted on heat conductors 71 and transmitted by dichroic filters 74 to a light guide 75 may have its color changed. Here, the dichroic filters 74 are designed such that they reflect light rays travelling at small angles with respect to a direction normal to a main surface of the filter, whereas light rays travelling at larger angles with respect to the normal direction are transmitted. As an example, blue light coupled into the light guide 75 is converted into white light by a patterned phosphor layer 78 provided on a main surface of the light guide 75. A mirror 77 is situated at the side of the phosphor layer 78 facing away from the light guide 75. Optionally, a redirection layer 79 may be used to further collimate the light, e.g. to avoid glare in a luminaire.

In an embodiment of a lighting assembly illustrated in FIG. 8a, an LED 80 placed on a heat conductor 81 and coupled to a dichroic filter 84, has a collimating structure or collimator 86 provided to it. The dichroic filter 84 is designed such that it transmits light rays travelling at small angles with respect to a direction normal to a main surface of the filter, whereas light rays travelling at larger angles with respect to the normal direction are reflected. The reflected rays are recycled and have a further chance to pass the filter at small angles. Accordingly, the brightness of the LED 80 is enhanced in a forward direction (i.e. a direction normal to a main surface of the LED 80). The main surface of the filter 84 may be parallel or normal to the main surface of a light guide (not shown) optically coupled to the collimator 86.

In an embodiment of a lighting assembly illustrated in FIG. 8b, the dichroic filter 84 is placed at an end of the collimator 86 facing away from the LED 80. A similar effect as the embodiment according to FIG. 8a is obtained.

Instead of a dichroic filter (a structure that is periodic in one dimension), a photonic crystal (i.e. an artificial structure that is periodic in two or three dimensions) may be used. Alternatively, instead of a dichroic filter, a periodic array of diffractive elements may be used. Both a photonic crystal and an array of diffractive elements allow the same function as a dichroic filter, as explained above in the different embodiments according to the present invention. Generically, the term ‘angular filter’ is used to indicate a dichroic filter, a photonic crystal, or an array of diffractive elements.

In the present invention, use of an LED showing a strong off-normal emission of light rays by tuning layer thicknesses of the LED, using the so-called cavity effect, allows less light to be reflected back by the dichroic filter to the LED, leading to a higher efficiency of the lighting assembly. Besides LEDs, other light sources may be used.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

While the invention has been described and illustrated in its preferred embodiments, it should be understood that departures therefrom may be made within the scope of the invention, which is not limited to the details disclosed herein.

1-15. (canceled)

16. A lighting assembly comprising:
an angular filter having a main surface;
a light guide having a main surface; and
a light source emitting light directed at the main surface of the light guide;
wherein the main surface of the filter is parallel to the main surface of the light guide, and
wherein the filter is configured to reflect light rays originating from the light source that are incident at small angles with respect to a direction normal to the main surface of the filter, and to transmit light rays originating from the light source that are incident at larger angles with respect to the direction normal to the main surface of the filter and then are captured inside the light guide.

17. The lighting assembly according to claim 16, wherein the filter is mounted on the main surface of the light guide.

18. The lighting assembly according to claim 16, wherein the filter is mounted on the light source.

19. The lighting assembly according to claim 16, further comprising a diffuser structure, wherein light rays from the light source and reflected by the diffuser structure enter the filter.

20. The lighting assembly according to claim 1, further comprising a mirror structure, wherein light rays from the light source and reflected by the mirror structure enter the filter.

21. The lighting assembly according to claim 16, wherein the light source comprises a light emitting diode.

22. The lighting assembly according to claim 16, wherein the filter comprises a dichroic filter.

23. The lighting assembly according to claim 16, wherein the filter comprises a photonic crystal.

24. The lighting assembly according to claim 16, wherein the filter comprises an array of diffractive elements.
